(19) United States
(12) Patent Application Publication
(10) Pub. No.: US 2007/0119542 A1
(43) Pub. Date: May 31, 2007

(54) Labeling method and apparatus

(76) Inventors: David Randall Williams, Fairport, NY (US); Jo Ann H. Squier, Bloomfield, NY (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/291,000

(22) Filed: Nov. 30, 2005

(51) Int. Cl. B65C 3/08; B32B 37/12; B65C 9/22

(52) U.S. Cl. 156/308.6; 156/215; 156/256; 156/539; 156/556; 156/566; 156/567; 156/568; 156/571; 156/578; 156/DIG. 9; 156/DIG. 35

(57) ABSTRACT

A method and apparatus for continuously applying labels to containers, and a container including a label on a surface thereof which has been applied thereto by the method and/or apparatus. An activating solution is sprayed by a sprayer onto a label pallet or directly onto a surface of a label containing an activatable coating or layer thereon. The activating solution activates the activatable coating or layer. The label is adhered to a container by placing the activated coating or layer of the label in contact with a surface of the container. The sprayer may deliver the activating solution to a surface of a label pallet or label with an even wet-out.

### FIELD OF THE INVENTION

This invention relates to a method and apparatus useful for applying polymer labels to a container, the labels having an activatable adhesive coating on the adhesive side of the label.

### BACKGROUND OF THE INVENTION

A number of systems exist for applying labels to containers. A typical system may utilize either roll-fed labels or cut-and-stack labels. Other systems are also known, but may be viewed generally as variations on the two primary systems, such as pressure sensitive labels.

Prior art labeling apparatus and methods employing labels in roll-fed form may also include label cutting and registration means for severing discrete labels from the roll and then registering them for attachment to the containers through, for example, a vacuum transfer drive system. In these continuous application systems, an adhesive may be applied to the label, such as a hot-melt adhesive. The hot-melt adhesive is typically applied to both the leading and trailing edge of the backside of the labels, though it may also be applied to the entire backside, for attaching labels to containers. Roll-fed labeling systems may commonly be used to apply labels sequentially to containers, such as bottles, tubs, or jars, in a continuous label application system.

As one alternative, cut-and-stack labels, i.e., labels that have been pre-cut off-line and are retained or positioned in a stack within a dispenser, such as a label magazine, may also be applied sequentially to containers, such as bottles, tubs, or jars, in a continuous label application system. The cut-and-stack method may also employ a cold-glue adhesive, which may be water-soluble, though a hot-melt adhesive may also be used. When a cold-glue adhesive is employed in a cut-and-stack method, it may be applied to a label pallet by a roller application system including a roller made of, for example, steel. A label pallet may be moved into contact with the first or exposed label of the stack to both apply the cold-glue to that label and remove the label from the stack through surface adhesion between the label and the relatively viscous and/or tacky adhesive. Thereafter, the label, with the cold-glue adhesive thereon, may be moved to a transfer drum, from where it may then be applied to a container, such as, for example, a bottle.

In one aspect of present labeling technology using cold glue type adhesives, the adhesive may be applied to the label by pumping the adhesive onto a spinning roller, which is then wiped by a label pallet, thus splitting the adhesive or solution between the roller and the pallet. Cut-and-stack labeling systems typically use a relatively viscous adhesive, such as, for example, a cold glue adhesive. Roll-fed systems employing hot-melt adhesives also include relatively viscous adhesive. Due to the viscosity of the adhesive, when the pallet contacts the roller to transfer the adhesive from the roller to the pallet, a pattern may commonly be generated on the surface of the pallet due to varying concentrations of adhesive across the pallet surface and resulting from the cohesive split of the adhesive between pallet and roller. This so-called “transfer splitting pattern” may be further passed to the label when the label is peeled from the pallet. A typical transfer splitting pattern may include a series of non-uniform peaks and valleys, and may result in uneven glue adhesion between label and container and impaired appearance. Uneven adhesion between label and container may result in (i) poor label adhesion to the container, (ii) a non-uniform label appearance, and (iii) an easily identifiable interface between label and container. The transfer split pattern may be transferred to the label when the label is removed from the pallet by the fingers and then transferred to the container.

Under an opaque label, the pattern or other visual imperfections may not be of significant concern, unless the appearance is manifest through the container wall, such as with clear containers, or if it appears on the surface of the label. However, under a transparent or clear label, the split-transfer adhesive pattern may notoriously appear through the label or otherwise impair the appearance of the labeled container. This problem may be particularly noticeable when trying to achieve a no-label look.

### SUMMARY OF THE INVENTION

In an aspect, the invention features a method for continuously applying labels to containers using labels comprising an activatable coating or layer on a surface of the label. The invention provides methods for reducing the appearance of the adhesive pattern on a labeled container. The invention generally comprises incorporating onto a backside of a label, those components of the adhesive system that may constitute the viscous components of a traditional adhesive system, such as a cold glue system, drying those components on the backside of the label when necessary, and thereafter applying an activating solution to the label substantially immediately before application of the label to the container. The activating solution may preferably constitute a solution that is relatively low viscosity as compared to an adhesive compound, such that the activating solution may relatively easily be applied to the adhesive-containing backside of the film by spraying, to activate the adhesive.

In one embodiment, an activating solution is sprayed onto a surface of a label pallet to achieve uniform distribution of adhesive on the label pallet and ultimately on the labeled container. The activating solution from the label pallet may be contacted or engaged with the surface of a label containing an activatable adhesive layer to activate the activatable adhesive layer. After activation, the label is adhered to a container by placing the activated coating or layer of the label in contact with a surface of the container. In another embodiment, an activating solution is sprayed directly on an activatable surface of the label and then the label is adhered to the container.

In another aspect, the invention features various apparatus for continuously applying labels to containers. In one aspect, the apparatus generally includes an assembly containing an activating solution, and a sprayer for delivering the activating solution. The label application section may include a reciprocating member, such as a rotating, conveying or linear-displacement member, further defined below. Rotating members may be preferred in some embodiments. The reciprocating member may contain one or more label pallets. The reciprocating member may be located so as to rotate, convey, or extend the label pallets in sufficient proximity to the sprayer to allow the activating solution to be delivered to a surface of each label pallet or label by spraying. The label application section further includes a label dispenser, such as a label magazine or other label support or positioning apparatus. The dispenser may preferably contain a plurality of individual labels in a stack. Each label contains an activatable coating or layer on a surface thereof. A first or exposed label in the stack may be located substantially within or along a path of travel of the label pallets after each of the label pallets has been sprayed with the activating solution. Each of the label pallets, with the activating solution thereon, may preferably be rotated or otherwise positioned in sufficient proximity of an exposed surface of the first label in the stack for the pallet to engage the exposed label surface to transfer the activating solution from the pallet to the label surface. The activatable coating or layer may thereby become activated. The label may be removed from the dispenser either mechanically or through surface adhesion with the pallet, to releasably secure the label to the label pallet. One or both of the label pallet and the container are then moved into engagement with each other to cause the label to adhere to the container.

The apparatus also includes a container handling device. The container handling device receives containers at an inlet, conveys and rotates the containers through the label application section, and then directs the containers with the labels applied thereon to an outlet. The container handling device may be positioned such that an individual label with the activated coating or layer thereon may be sequentially directed into contact with a surface of a discrete container as the discrete container is directed through the label application section.

In yet another aspect, the invention features a second method for continuously applying labels to containers. An activating solution may be sprayed directly onto a surface of a label containing an activatable coating or layer thereon. The activating solution activates the activatable coating or layer. The label may be adhered to a container by placing the activated coating or layer of the label in contact with a surface of the container.

In a further aspect, the invention features a second apparatus for continuously applying labels to containers. The second apparatus may include a conveyor for moving containers to be labeled. The second apparatus may also include a label positioning mechanism, such as a rotatable vacuum drum assembly. The second apparatus may further include a supply of roll-fed labels. The labels contain an activatable coating or layer thereon and are dispensed singly onto a label-receiving face of the rotatable vacuum drum assembly. The second apparatus additionally includes an activating solution assembly containing an activating solution and a sprayer for delivering the activating solution. The activating solution assembly may be disposed sufficiently adjacent to the label positioning mechanism in order to deliver the activating solution to the activatable coating or layer of the labels by spraying.

In a still further aspect, the invention features a container comprising a label on a surface thereof which has been applied thereto by a method according to any aspect of the invention. The container includes an adhesive interface between the surface of the container and the label. The adhesive interface contains the activated coating or layer.

The labels may be cut-and-stack labels. The labels may be roll-fed labels. The roll-fed labels may be full-wrap roll-fed labels. The roll-fed labels may be partial-wrap roll-fed labels. The labels may be transparent plastic labels. The labels may be opaque plastic labels.

The surface energy of the surface of the label pallet, if any, which receives the activating solution, may be higher than the surface tension of the activating solution. The surface of the label pallet, if any, which receives the activating solution may contain a coating or material thereon such that the surface energy of the surface of the label pallet which receives the activating solution is higher than the surface tension of the activating solution. The activating solution may contain a surfactant which lowers the surface tension of the activating solution such that the surface energy of the surface of the label pallet, if any, which receives the activating solution is higher than the surface tension of the activating solution.

Also, after adhering the label to a container by placing the activated layer of the label in contact with a surface of the container, the labeled container may be passed through one or more rollers to affirm uniform label adhesion and remove excess adhesive or activating solution. The adhesive interface between the surface of the container and the label may be free of a transfer splitting pattern. Embodiments of the invention may also have one or more of the following advantages.

The assembly containing an activating solution and a sprayer may deliver the activating solution to a surface of a label pallet or label with a substantially even or uniform wet-out, as compared to roller-applied activator or adhesive application. A labeled container may be produced that possesses improved label/container adhesion and a uniform and smooth adhesive interface may be provided between the label and container. The smooth adhesive interface may be continuous, i.e., free of discontinuities. The label of a labeled container may have an excellent appearance. The label of a labeled container may be free of visual imperfections, such as, for example, an adhesive transfer splitting pattern and/or brush scratches. In the case of transparent plastic labels, the labeled container may benefit from a relatively “no-label” appearance.

### BRIEF DESCRIPTION OF THE DRAWINGS

FIG. 1 is a schematic, plan view illustrating an embodiment of a cut-and-stack labeling method and apparatus, according to the present invention.

FIG. 2 is a fragmentary isometric view of a portion of an assembly according to this invention, wherein an activating solution may be sprayed onto an exposed surface of a label pallet, prior to the label pallet being directed to a transfer station for receiving a label thereon.

FIG. 3 is a fragmentary isometric view according to this invention, illustrating a label pallet with activating solution thereon being placed into contact with a first label in a stack of labels.

FIG. 4 is a fragmentary isometric view according to the present invention, illustrating, in schematic form, the retention of a label on a transfer assembly that directs the label to a label applicator station.

FIG. 5 is a schematic top view of a roll-fed labeling apparatus, according to the present invention.

### DETAILED DESCRIPTION OF THE INVENTION

As used herein, the terms “spray”, “spraying,” “sprayer,” and “sprayed” may be defined broadly as encompassing all forms of spraying and sprayers, suitable for delivering an activating solution through a spatial medium, to a label surface, including, but not limited to, atomizing and atomizers, misting and misters, fogging and foggers, and spraying and sprayers. Furthermore, the term “spraying” refers to any method or system for delivering, applying, diffusing, or otherwise distributing multiple droplets of liquid through or into an atmosphere.

As used herein, the term “wet-out” refers to the wetting of a solid surface or tendency to spread on a solid surface, by a liquid or solution, wherein the term “wetting” refers to the interfacial free energy when a liquid is placed in contact with a solid surface, resulting in a contact angle, θ, of less than 90 degrees.

As used herein, the term “continuously” in reference to “continuously applying labels” refers to the fact that each of the methods and apparatuses for applying labels to containers may be used as part of a system for applying labels to containers, typically at a rate of 10 containers/minute or more. For example, in some embodiments, a method and/or apparatus for applying labels to containers may be used as part of a system for applying a label to a wine or spirit container at a rate of over 50 containers/minute, and in some preferred embodiments, at a rate of over 100 containers/minute. In other embodiments, the method and/or apparatus for applying labels to containers may be used as part of a mechanical system for applying a label to a beer, juice, soft drink or water container at a rate of over 500 containers/minute, and in other preferred embodiments, at a rate of over 800 containers/minute. The methods and apparatus for applying labels to containers may be employed in substantially any system for applying labels to containers, including but not limited to, systems employing cut-and-stack labels and systems employing labels in roll-fed form.

The methods and apparatus of the present invention are applicable to labels, such as polymeric and/or paper, that contain an activatable adhesive layer on an exterior surface of the label. The activatable adhesive layer contains the adhesive or components of the adhesive mixture used, at least in part, to adhere the label to the container. The activatable adhesive layer is activatable by contacting the activatable adhesive layer with an activating solution substantially immediately before the label is to be applied to the container. The viscosity of many commonly used labeling adhesives, such as cold glue adhesives or hot-melt adhesives, may be too high to permit efficiently and effectively spraying the solution onto the label. This invention involves applying an adhesive component to the label and drying that component before the label is activated for adhesion to the container. Thereafter, when it is desired to apply the label to the container, a lower viscosity, efficiently sprayable component of the adhesive system can be sprayed onto the adhesive layer of the label. The relatively lower viscosity composition that is sprayable may be referred to as the “activator solution,” regardless of the interaction between the activator solution and the activatable adhesive layer, e.g., whether by rehydration and/or chemical interaction. This invention comprises generally, two basic methods for applying labels to containers; one by spraying the activator solution onto a label pallet and engaging the label pallet with the activatable label surface; and a second method comprising spraying the activator solution directly onto the surface of a label comprising an activatable surface.

In one method for applying labels to containers according to this invention, the apparatus and method comprises utilizing a label pallet. The inventive method comprises spraying an activating solution onto a surface of a label pallet so that the activator solution can be transferred to the activatable adhesive layer of the label when the pallet and label are contacted with each other. A label may be positioned to receive the activating solution from the pallet, the label including an activatable adhesive layer on a surface of the label. The terms “position” or “positioned” are used broadly to encompass substantially any means of supporting, holding, or providing a label for spraying, repositioning, or contacting a container or other component. The term “label dispenser” is also used broadly to mean and include substantially any apparatus or magazine for supporting, positioning, providing, holding, or manipulating one or more labels, including a stack or roll of labels.

The method also comprises the step of contacting the activating solution on the pallet with the activatable adhesive layer of the label to activate the activatable adhesive layer on the label. Due to even spraying of the activator solution and the relatively lower viscosity and adhesive properties of the activator solution, the activated label may possess an adhesive surface that has improved uniformity of thickness, as compared to prior art liquid-adhesive-based labeling systems such those using hot or cold glue adhesive. Additionally, the separation of the activatable label surface from the label pallet may have reduced propensity toward producing a transfer splitting pattern as compared to the prior art systems. The activating solution should be of sufficiently low viscosity to be sprayable and of sufficiently low surface tension as compared to the surface energy of the label pallet to wet-out and substantially, uniformly cover the surface of the label pallet. It is also desirable that the surface tension of the activator solution is lower than the surface energy of the activatable adhesive layer of the label to enhance uniform distribution of the activator solution on the activatable adhesive layer after separation of the activatable adhesive layer and the label pallet.

According to some preferred methods, the releasably adhered label may be removed from the label dispenser by the pallet, to the container. If desired, the activated label may be removed from the pallet by a mechanism, such as a set of mechanical fingers, and adhered to the surface of the container. As for the apparatus and methods for manipulating and engaging each of the sprayer, the spray solution, the pallet, the label, and the container to be labeled, each or any of such components may be manipulated relative to the other components, as desired, to complete transfer of the activator solution from the sprayer, to the pallet, to the label and finally to the container/label interface. For example, the pallet may be supported on a reciprocating member wherein the pallet reciprocates along a repeating course. The term “reciprocating” as used herein may be defined broadly to include substantially any movement mechanism for any or all of these components, including, without limitation, at least one of (1) a rotating member, (2) a conveyor member, and/or (3) an extending and retracting member, such as a linkage and/or cam device. It is merely necessary that the dynamic components(s) move along an automated or repeating course to facilitate repeatability of a substantially continuous labeling operation. For example, the pallet may be moved to within a spray zone of an activating solution spray nozzle, or moving the container to cause the surface of the container to contact the activated layer of the label. To ensure that the activating solution spreads and wets-out properly on the surface of the label pallet, in some applications it may be desirable to provide a coating on the surface of the pallet such that the surface energy of the surface of the pallet is greater than the surface tension of the activating solution.

Depending upon the labeling application, and whether the labels are roll-fed labels or cut-n-stack labels, it may frequently be desirable to spray the activating solution to cover at least a majority of surface area of the pallet that is contacted by the label. For example, it may be desirable to provide substantially full coverage of the label surface with the spray of activator solution. In other applications, it may be desirable to spray the activating solution to cover less than a majority of the surface area of the pallet that is contacted by the label, in one of a (i) fixed pattern, such as in an “x” pattern or around the perimeter of a label; (ii) a stripe, such as in roll-fed partial wrap or full wrap applications; and (iii) a repeating pattern, such as a field of dots or stripes or circles.

In another method according to this invention, it may be desirable not to utilize a label pallet for applying the activating solution to the label, and instead to directly spray the activator solution directly onto the activatable label surface. Such method may comprise the steps of positioning a label to receive an activating solution from an activating solution sprayer, the label including an activatable adhesive layer; and spraying an activating solution directly onto the activatable adhesive layer to activate the activatable adhesive layer. After spraying the label, the activated layer of the label may be contacted with a surface of a container to adhere the label to the container. As with the previous method, the label preferably may be removed from a label dispenser prior to spraying the activatable adhesive layer with activating solution, or the exposed activatable adhesive layer may be sprayed while the label is supported within the label dispenser. The label dispenser may dispense the label or labels as individual labels, including labels from a label stack, as well as roll-fed labels. The method may also comprise the step of releasably securing the label to a vacuum drum, either before or after spraying and activation. Also, the spray methods described herein may comprise moving any or all of the various components to facilitate application of the activation solution to the label surface and to manipulate the label from a label positioning or dispensing apparatus, through a spray zone, and apply the activated label to the container.

This invention also includes apparatus that are useful for labeling containers according to the methods of this invention. The invention still further comprises containers that are labeled according to the methods described and claimed herein.

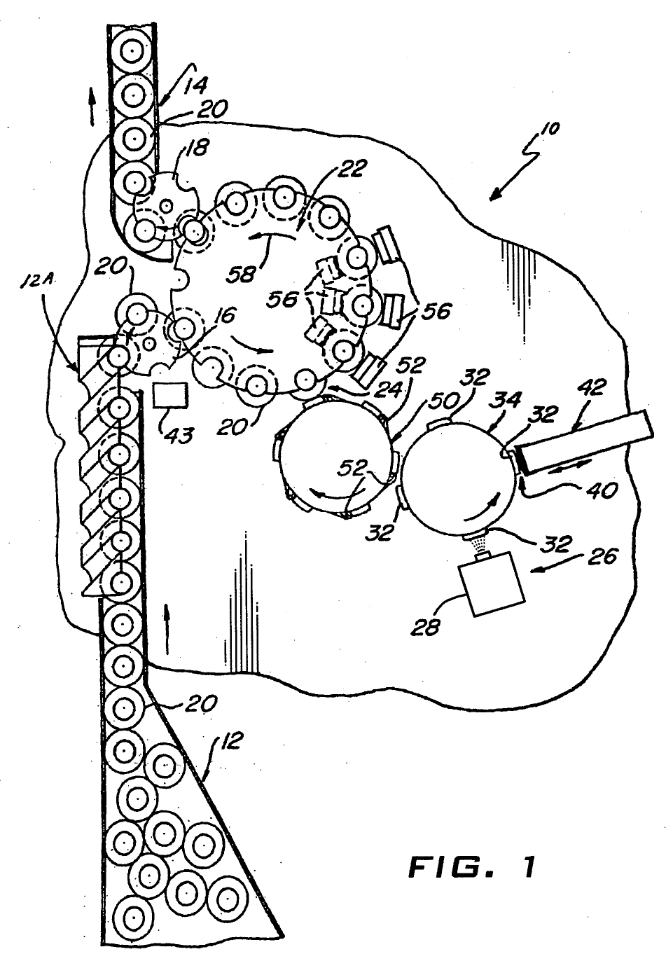

FIGS. 1-4 illustrate an example of an apparatus and method, shown generally at 10, for continuously applying labels to containers in a “straight-through” rotary system employing cut-and-stack labels. Other cut-and-stack label systems may be used, including but not limited to, parallel cut-and-stack rotary label systems, right-angle cut-and-stack rotary label systems, and cut-and-stack label systems which do not require the use of a rotating turret to handle the bottles, or other containers, during the label application operation.

There may be provided an inlet conveyor section 12, an outlet conveyor section 14 and rotating bottle-transfer members 16 and 18 for transferring bottles 20 from inlet conveyor section 12 to a rotating turret 22, and for removing bottles from rotating turret 22 to outlet conveyor section 14, respectively, after the bottles have been directed through a label applicator station 24.

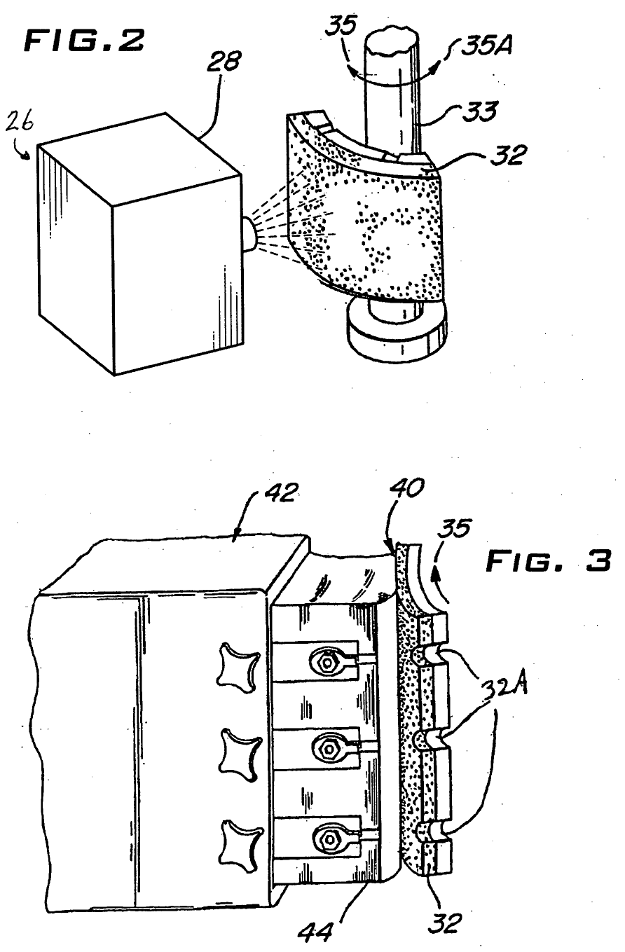

Referring to FIGS. 1 and 2, an assembly 26 may include a sprayer 28 and a storage tank (not shown) or activating solution source reservoir, for containing an activating solution to be delivered via sprayer 28. Assembly 26 may also include a system for conveying the activating solution from a tank to the sprayer, which may include, for example, one or more of a pump, an air blower, a compressor, tubing, pipe, and a hose, or such a conveying system may be a part of sprayer 28. Assembly 26 may further include a system which may contain one or more of, for example, a photo detection system, a solenoid, and an electrical or mechanical timer, for controlling sprayer 28 so that it sprays only when desired. Alternatively, such a control system may be directly incorporated as part of sprayer 28. Further, sprayer 28 may comprise a plurality of nozzles and/or nozzle jets to apply the spray in the desired fashion. Nozzle selection depends upon numerous factors, including activating solution composition, the pressures and hydraulics involved, and the level of activator solution desired or required in the particular labeling application.

The type of sprayer which may be used as sprayer 28 is not particularly limited. Sprayer 28 may, in certain embodiments, include means for reducing the activating solution to droplets and/or for directing the activating solution to the application point, such as, for example, a nozzle, jet, atomizer, or nebulizer, including electrostatic sprayer technologies, such as may be used with ink jet printers. In preferred embodiments, sprayer 28 delivers a controlled, metered layer of activating solution directly onto the exposed surface of each label pallet 32. Sprayer 28 may enable assembly 26 to deliver the activating solution to the surface of the label pallet with an even wet-out. The spray may be delivered in any desired pattern, such as but not limited to, a broad spray for covering at least a majority of a label or pallet surface, and in many preferred embodiments, covering generally all the label or pallet surface with a substantially uniform coating or coverage of activator solution. In other embodiments, the spray may be delivered in a substantially linear, stripe, or rectangular pattern, such as may be useful with applying the solution to the leading and/or trailing edges of a wrap-around label. In still other embodiments, the spray may be delivered in a repeating pattern, such as in a pattern of dots, stripes, crosshatching, or peripheral spray coverage.

The composition of the activating solution which may be sprayed by sprayer 28 is not particularly limited. For example, the activating solution may contain water or any chemical fluid which serves to activate the activatable adhesive layer of a label. An activatable adhesive layer may comprise an exterior layer that is formed as an integral part of a label or label material, such as a coextruded layer of a multilayer polymer film. Alternatively, such activatable adhesive layer may comprise a layer that is coated or applied to a label or label material, such as a coating or laminated layer.

In certain embodiments, the activating solution may contain a mixture of water and another additive, such as at least one additive selected from the group comprising adhesives, crosslinking agents, surfactants, and thickening agents. An adhesive which may form a part of the activating solution is not particularly limited and may include, for example, casein, starch or a synthetic adhesive. A crosslinking agent which may form a part of the activating solution is not particularly limited and may include, for example, a metal-based crosslinker, such as ammonium zinc carbonate, a borate, or an aziridine. A thickening agent for increasing the viscosity of the activating solution is not particularly limited and may include, for example, Laponite (a synthetic clay), other clay and clay-like materials, or an aluminum silicate. In other embodiments, the activating solution may be a non-aqueous, solvent-based solution, such as, for example, an organic solvent-based solution. In some preferred embodiments, the activating solution contains water, and in certain particularly preferred embodiments, the activating solution consists of water or consists of water and a surfactant.

Referring again to FIGS. 1 and 2, each of label pallets 32 may be mounted on a rotating support member 34 or support shaft 33. Alternatively, the pallets may be mounted on a support member that moves back and forth in an oscillating motion, such as illustrated by arrow heads 35 and 35A, in FIG. 2. Still other embodiments may provide oscillating components, such as shaft 33 and pallet 34 in a rotating member 34. Oscillatory motion may be provided by, for example, a cam-drive arrangement. Such a cam-drive arrangement is employed in many conventional cut-and-stack labeling systems, such as those manufactured by, for example, KRONES AG in West Germany or KRONES, Inc. in Franklin, Wis. (Krones AG and Krones, Inc. hereinafter collectively being referred to as “KRONES”). As each label pallet 32 is moved past sprayer 28, such as by rotation of support member 34, the activating solution may be sprayed, preferably uniformly, onto each label pallet 32.

Label pallets 32 may be made of any suitable material. In certain embodiments, label pallets 32 may be made of a rubber, a foamed rubber, a plastic, such as, for example, a photo polymer of the type used in a flexographic system, or a metal, such as, for example, aluminum. For example, in particular embodiments, label pallets 32 may be formed of a smooth surface elastomer (natural or synthetic) having a Shore A hardness in the range of from about 50 to about 90. A labeling apparatus may comprise a single pallet or multiple pallets.

In preferred embodiments, the surface energy of the surface of each label pallet 32 which receives the activating solution may be higher than the surface tension of the activating solution to facilitate wet-out of the activating solution on the pallet surface. Wet-out may be improved by such an arrangement. If the surface energy of the label pallet is lower than the surface tension of the activating solution being applied to the label pallet, it may, in some cases, be difficult to achieve an even wet-out of the sprayed droplets of activating solution without overly flooding the surface of the pallet with sprayed solution.

In certain embodiments, the surface of each label pallet 32 which receives the activating solution may contain a coating or comprise a material thereon to ensure that the surface energy of the surface of each label pallet 32 that receives the activating solution is higher than the surface tension of the activating solution. Alternatively, the surface of each label pallet 32 which receives the activating solution may contain a coating thereon of a material that can be treated periodically to keep the surface energy high. As another alternative, the surface of each label pallet 32 which receives the activating solution may be roughened, treated, or foamed or otherwise treated or prepared to increase its surface energy.

In other embodiments, the activating solution may contain a surfactant to lower the surface tension of the activating solution to ensure that the surface energy of the surface of each label pallet 32 which receives the activating solution is higher than the surface tension of the activating solution. A surfactant which may be added to the activating solution is not particularly limited, and may include, for example, a wetting agent such as, for example, SURFYNOL, an ethoxylated amine available from Air Products and Chemicals. The combination of a coating on the surface of the label pallet and a surfactant in the activating solution may also be employed.

Referring to FIGS. 1 and 3, label pallets 32, with the activating solution thereon, may be directed sequentially by rotating reciprocating member 34 to a transfer station 40. Transfer station 40 may include a label dispenser, such as a magazine type dispenser 42 containing a stack of cut labels 44 therein. Magazine 42 may be mounted for linear reciprocating motion toward and away from the exposed surface of the label pallets, respectively.

The composition and structure of labels 44 is not particularly limited. For example, the labels may be paper or plastic/polymeric. The plastic labels may be transparent or opaque. The labels may be monolayered or multilayered. The labels may include a metallized layer. In certain preferred embodiments, one or more layers of the label may include at least one of, for example, polypropylene, polyethylene, and polyethylene terephthalate (PET).

The labels include an activatable coating or layer as an outermost surface of the labels. In magazine 42, the labels may be arranged such that, for the first or exposed label in the magazine, the activatable coating or layer is preferably the exposed surface of the label. The activatable coating or layer is a potentially adhesive coating or layer that may be substantially not adhesive prior to being activated by the activating solution, e.g., when moistened or wet through application of the activating solution. The phrase “substantially not adhesive” refers to the fact that the activatable coating or layer, if not activated, may not adhere to a label pallet or container in a manner permitting effective operation of a method or apparatus for continuously applying labels to a container.

The composition of the activatable coating or layer is not particularly limited. In some embodiments, the activatable coating or layer may include at least one of, for example, animal glue, a water-based casein adhesive, or a water-based starch adhesive. In certain preferred embodiments, the activatable coating or layer includes an animal glue-based aqueous solution that has been dried.

In certain embodiments, a label may include a printable coating or layer on a side of the label opposite the activatable coating or layer in order to provide the label with a printable outer surface. In other embodiments, a label may include an adhesion-enhancing coating or layer as an intermediate, or tie, layer between the base film of the label and the activatable coating or layer. The label may also include an antiblock agent or particulate to reduce label blocking with adjacent labels and feeding equipment.

The reciprocating movement of magazine 42 and/or the pallet 32 may be controlled, in some embodiments, by a conventional photo detection system 43, (see FIG. 1) which may be positioned to detect the presence of a container, a label, a sprayer, or a pallet at a specified location, preferably at the downstream end of a helical feed roll 12A of inlet conveyor 12. If a container is detected at the specified location of inlet conveyor 12, the magazine 42 may be moved into, or may be maintained in, a forward position for permitting a desired label pallet 32 to engage and remove the exposed label from the stack of cut labels 44 retained in the magazine. The desired label pallet 32 may be the one that receives a label that ultimately will be aligned with the detected container when that container is in label applicator station 24 of rotating turret 22, to thereby transfer, or apply, the label to the container. If a container is not detected at the specified location by photo detection system 43, then magazine 42 may be retracted to preclude a label pallet 32 from engaging and receiving the exposed label in magazine 44, which label ultimately may have been directed to an empty container position at label applicator station 24 on turret 22 resulting from a container not being in the specified location being monitored by the photo detection system.

Still referring to FIGS. 1 and 3, when a label pallet 32 is in a position aligned for engaging exposed label 44 carried in magazine 42, that pallet may be oscillated in the clockwise direction of arrow 35, as viewed in FIG. 3, for engaging exposed label 44 in magazine 42 to both apply the activating solution to that label and remove that label from the stack through surface adhesion from the now-activated activatable coating or layer of the label.

There may be an advantage to the fact that the activating solution may be applied to label 44 from label pallet 32 after having been sprayed onto the pallet by sprayer 28. Spraying activating solution onto label pallets 32 may prevent a transfer splitting pattern from occurring and from being passed onto label 44. The more uniform application of activating solution may aid in creating a uniform label appearance. In addition, in the case of certain transparent plastic label embodiments, the labeled container may benefit from a “no-label” appearance when the activating solution is sprayed onto label pallets 32, such that the interface between label and container may be less obvious than with roller-applied activating solution application methods.

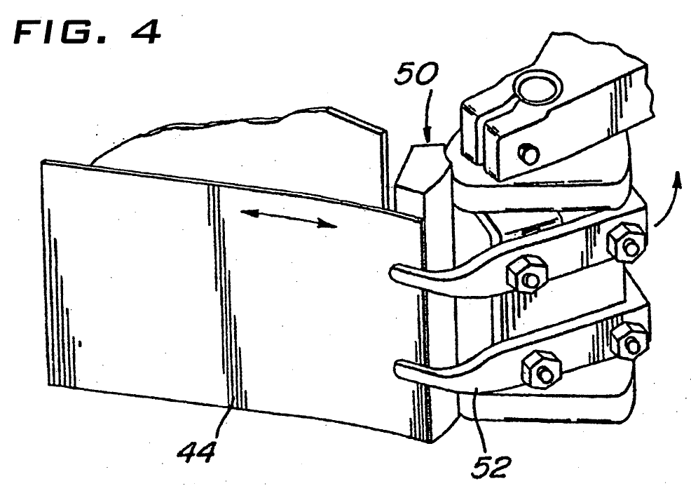

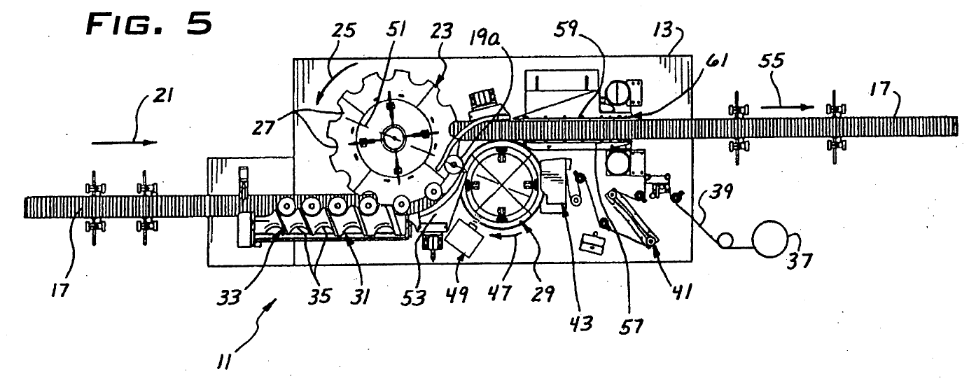

Referring to FIGS. 1 and 4, label pallets 32, with the labels thereon, may be rotated by support member 34 to a transfer assembly shown generally at 50. Transfer assembly 50 may include, for example, a plurality of cam-operated gripping members 52 disposed about the periphery thereof for engaging labels 44 carried by label pallets 32 and transferring the labels to transfer assembly 50. Transfer assembly 50 may be generally of any functionally operative design. For example, gripping members 52 may engage labels 44 carried on label pallets 32 in the regions of the labels aligned with cut-outs 32A in label pallets 32, as is best illustrated in FIG. 3. During transfer of the labels to transfer assembly 50, label pallets 32 may be oscillated in the direction of arrow 35A, as viewed in FIG. 2.

Referring again specifically to an embodiment of an apparatus and method as illustrated in FIG. 1, each of labels 44 containing the activated coating or layer thereon may be rotated into a position for engaging the periphery of a container 20 carried on turret 22 in label applicator station 24. The spacing of the labels on transfer assembly 50 and the speed of rotation of the transfer assembly may be timed with the speed of rotation of rotating turret 22 such that each label carried on transfer assembly 50 may be sequentially directed into engagement with an adjacent bottle carried on the rotating turret. Moreover, photo detection system 43, if present, may prevent a label from being carried to label applicator station 24 when a bottle for receiving such label is missing from that station.

Still referring to FIG. 1, each of labels 44 may be applied at, for example, its midline to the periphery of an adjacent container 20, thereby providing outer wings extending in opposed directions from the center line of the label, which is adhered to the bottle. The specific manner of applying the labels to the containers is not particularly limited, however, and labels may be applied to a surface of a bottle in other ways.

After a label 44 initially is adhered to a bottle 20 in label applicator station 24, rotating turret 22 may direct each bottle, with the label attached thereto, through a roller station containing at least one roller or, in preferred embodiments, a series of rollers 56, as shown in FIG. 1. As bottles 20 are directed through the series of rollers 56, bottles 20 may also oscillate back and forth about their central axis to thereby create an interaction between the bottles, labels and rollers to ensure further intimate contact between label and container. For example, in one embodiment, a first roller may apply pressure to a label on a container beginning at the middle of the label and continuing to a first outside edge of the label. A next roller in the roller station may apply pressure to the label beginning at the middle of the label and continuing to a second outside edge of the label. In certain embodiments, the rollers of the roller station may be timed to a computer.

Advantageously, the labels may be smoothed down and any trapped air may be squeezed out by passing the bottles through a label smoother station, including components such as a roller, an air knife, or a wiper blade. Although the smoother station may be located at any point after the label application section, the smoother station preferably may be located after the label application section and before outlet 14 of the container handling device, as shown in FIG. 1.

Smoothing brushes may also be used supplemental to or as an alternative to the smoothing station. In preferred embodiments, however, the smoothing station is used in the absence of smoothing brushes. Some smoothing brushes may be too harsh for certain film label embodiments and may scratch the film surface. Smoothing brushes may also not smooth in a continuous pattern. If smoothing brushes are used, the brush bristle length, brush stiffness, and brush array (the orientation of the brushes to the label position) may each be adjusted to maximize smoothing while minimizing damage to the label. In certain embodiments using smoothing brushes, a first pair of brushes may be focused on the center of the label and successive pairs of brushes may proceed to the edges of the label. Still referring to FIG. 1, bottles 20 may be carried by rotating turret 22 in the direction of arrow 58 to bottle-transfer member 18, at which point bottles 20 may be transferred to outlet conveyor section 14 for subsequent packaging.

FIG. 5 illustrates an example of an apparatus and method according to the present invention, illustrated generally at apparatus 11, for continuously applying labels to containers in a system employing roll-fed labels. Other roll-fed label systems may alternatively be used. Referring to FIG. 5, apparatus 11 may include a housing 13. A conveyor 17 such as a link-belt conveyor may move containers 19a toward apparatus 11 in the direction of the arrow 21.

Containers 19a on the conveyor 17 may be first received in the apparatus 11 by a starwheel assembly 23. Starwheel assembly 23 may rotate as illustrated by arrow 25 and may receive containers 19a one-by-one in successive pockets 27, moving them in the direction of arrow 21 toward a vacuum drum assembly 29, which may function as a label applying station. An infeed screw assembly 31 may include, in part, a rotating feedscrew 33, which may also include, in some embodiments, a plurality of pockets 35 for receiving individual containers 19a as they travel into apparatus 11. Feedscrew 33 may space containers 19a in a regulated manner prior to their contact with starwheel assembly 23, so that they may feed into starwheel pockets 27 without jamming.

In some embodiments, a roll of labels 37 may provide a continuous web 39 that may be drawn through a feed roller system, indicated generally at 41, to a cutter assembly 43. The composition and structure of the labels may be the same as described earlier herein with respect to the cut-and-stack system. Cutter assembly 43 may be in close proximity to vacuum drum assembly 29, and may be adapted to operate in conjunction therewith. Cutter assembly 43 may cut the roll-fed labels to be full-wrap roll-fed labels or partial-wrap roll-fed labels, as desired.

Vacuum drum assembly 29 may include a vacuum draw system (not shown) for drawing a vacuum along its perforated surface to engage label web 39 and move it into contact with a knife edge which may be positioned adjacent to a cutter roll (not shown) within the cutter assembly. A label cutting blade may engage the knife edge to cut web 39. The vacuum draw in the cutter roll may maintain the cut label on the roll surface until it reaches a point where the label may be transferred to the label drum by reducing the vacuum and blowing a jet of air outwardly from the cutter roll to assist in label transfer.

The severed labels may be received onto vacuum drum assembly 29. A drive mechanism (not shown) may be operatively connected to vacuum drum assembly 29 and may provide the motive force for rotating the drum assembly. The labels on the drum may be rotated in the direction of the arrow 47 to an assembly including a sprayer 49 and a storage tank (not shown) for storing an activating solution to be delivered via sprayer 49. The assembly and sprayer 49 may generally function similarly with respect to either roll-fed labeling systems or cut-and-stack labeling systems as described previously herein, particularly with respect to assembly 26 and sprayer 28. Activating solution may be applied to a portion of the surface of the label that is exposed on drum 29 by sprayer 49. The surface of the label that is exposed on drum 29 may contain the activatable coating or layer, and the activatable coating or layer may be activated by the spray of activating solution from sprayer 49. In certain embodiments, a moisture trap may be included on the vacuum line going to drum 29 to prevent, or reduce the likelihood of, excess activating solution being carried into a pump or blower.

Drum 29 may rotate the leading edge of the label having the activated coating or layer until it is approximately in alignment with an imaginary line 51 between the rotational axis of vacuum drum 29 and starwheel assembly 23. In FIG. 5, for example, container 19a is illustrated as being at this labeling point. Imaginary line 51 may also coincide with the termination of an arcuate infeed guide 53. Container 19a in the pocket or cusp 27 of starwheel 23 may be pushed by the starwheel 23 into engagement with the leading edge of the label and the label may wrap itself around container 19a, which container continues counter-clockwise rotation to continue the labeling process. In-feed guide 53 may, in combination with starwheel assembly 23, serve to present container 19a squarely to vacuum drum assembly 29 when the container 19a first contacts the label.

Once container 19a has been labeled, it may exit apparatus 11 in the direction of arrow 55 by traveling along conveyor belt 17 between a pair of stabilizer belts 57, 59, respectively, which together form a stabilizer belt assembly 61. Assembly 61 may stabilize the containers on conveyor 17 and prevent the containers from falling off of the conveyor system, ensure smooth progression to a downstream location, for packaging or further processing. A device, such as, for example, an air knife or squeegee, may be employed, for example, between the point where the label is applied to a container and the point where drum 29 picks up the next label, for removing any excess activating solution from the surface of drum 29.

As described earlier herein with respect to the cut-and-stack system, a smoothing station (not shown) and/or smoothing brushes (not shown) may be used at some point after initial application of the label to the container to ensure further intimate contact between label and container. In some embodiments, a smoothing apparatus other than smoothing brushes may be preferred to affirm that the label is completely and smoothly adhered to the container.

Containers labeled according to the methods and apparatus of the present invention, prepared from roll-fed labels, cut-and-stack labels or otherwise, may possess excellent label/container adhesion, and a smooth, continuous, adhesive interface may be provided between the label and container. Furthermore, a container labeled according to this invention may have an improved appearance as compared to containers labeled according to the prior art. The labeled container may be relatively free of visual imperfections, such as, for example, a transfer splitting pattern and/or brush scratches. In the case of transparent plastic labels, the labeled container may benefit from a “no-label” appearance. That is, a visual inspection of the labeled container may not readily reveal the fact that the container actually has a label on it, appearing instead as though the, e.g., graphics on the label are somehow printed directly on or made part of the container itself.

Further embodiments are within the following claims.

What is claimed is:

1. A method for applying labels to containers, comprising:
spraying an activating solution onto a surface of a pallet;
positioning a label to receive the activating solution from the pallet, the label including an activatable adhesive layer on a surface of the label;
contacting the activating solution on the pallet with the activatable adhesive layer of the label to activate the activatable adhesive layer and form an activated adhesive layer on the label; and
applying the label to a container.

2. The method of claim 1, further comprising the steps of:
releasably adhering the activated label to the pallet; and
removing the releasably adhered label from a label dispenser with the pallet.

3. The method of claim 2, further comprising the steps of:
contacting the activated adhesive layer with a surface of the container to remove the releasably adhered label from the pallet to apply the label to the container.

4. The method of claim 1, wherein the label is an individual label within a stack of individual labels.

5. The method of claim 1, wherein the label is dispensed from a label magazine.

6. The method of claim 1, further comprising the step of:
supporting the pallet on a reciprocating member wherein the pallet reciprocates along a repeating course.

7. The method of claim 6, wherein the reciprocating member comprises at least one of (1) a rotating member, (2) a conveyor member, and (3) an extending and retracting member.

8. The method of claim 1, further comprising
moving the pallet within a spray zone of an activating solution spray nozzle.

9. The method of claim 1, further comprising the step of:
moving the container to cause the surface of the container to contact the activated adhesive layer of the label.

10. The method of claim 1, wherein the label comprises at least one of a polymeric film and a paper film.

11. The method of claim 1, further comprising the step of:
repositioning at least one of the sprayer and the pallet after adhering the label to the container to respray the activating solution onto the surface of the pallet; and
positioning a second label to receive the activating solution from the pallet to sequentially adhere labels to containers.

12. The method of claim 1, further comprising the step of:
engaging the labeled surface of the container with at least one of a wiper blade, an air stream, and a roller to enhance adherence of the label on the container.

13. The method of claim 1, wherein the label is an individual label separated from a roll of roll-fed labels.

14. The method of claim 1, further comprising the step of:

15. The method of claim 1, further comprising the step of:
providing an activating solution characterized by a surface tension that is lower than the surface energy of the surface of the pallet.

16. The method of claim 1, wherein the activating solution comprises a surfactant such that the surface tension of the activating solution is lower than the surface energy of the surface of the pallet.

17. The method of claim 1, wherein the surface tension of the activating solution is lower than the surface energy of the activatable surface when the activating solution is applied to the activatable surface.

18. The method of claim 1, further comprising the step of:
spraying the activating solution to cover at least a majority of surface area of the pallet that is contacted by the label.

19. The method of claim 1, further comprising the step of:
spraying the activating solution to cover less than a majority of the surface area of the pallet that is contacted by the label, in one of a (i) fixed pattern; (ii) a stripe; and (iii) a repeating pattern.

20. The method of claim 1, further comprising the step of:
moving the spray nozzle relative to the pallet while spraying the activating solution on the pallet.

21. The method of claim 1, further comprising the step of:
moving the pallet relative to the spray nozzle while spraying the activating solution on the pallet.

22. A labeling apparatus for applying labels to containers, comprising:
a pallet including a pallet surface for releasably supporting a label on the pallet surface;
a sprayer for delivering an activating solution onto the pallet surface; and
a label positioning mechanism for positioning a label comprising an activatable adhesive layer prior to the label being releasably supported on the pallet surface, prior to the label being adhered to the container.

23. The labeling apparatus according to claim 22, wherein the label positioning mechanism is a label dispenser.

24. The labeling apparatus according to claim 22, further comprising:
means for engaging a label supported by the label positioning mechanism with the pallet surface to releasably support the label on the pallet surface.

25. The labeling apparatus according to claim 22, further comprising:
means for spraying a label activating solution onto an activatable surface of the label supported by the label positioning mechanism.

26. The labeling apparatus according to claim 22, wherein the label includes an activatable adhesive layer comprising an activatable surface on the activatable adhesive layer.

27. The labeling apparatus according to claim 22, further comprising:
means for releasing a label that is releasably supported on the pallet surface.

28. The labeling apparatus according to claims 22, further comprising:
means for engaging the label with a surface of a container when the label is releasably adhered to the pallet surface.

29. The labeling apparatus according to claim 22, further comprising:
at least one of a roller, a wiper blade and an air stream to engage the labeled surface of the container to enhance adherence of the label on the container surface.

30. The labeling apparatus according to claim 22, further comprising:
a reciprocating member to support at least one of (1) the pallet, and (2) the sprayer.

31. The labeling apparatus according to claim 30, wherein the reciprocating member supports the pallet and further comprises at least one of (1) a rotating member, (2) a conveyor member, and (3) an extending and retracting member, wherein the pallet moves along a repeating course

32. The labeling apparatus according to claim 22, further comprising:
means for energizing the sprayer.

33. The labeling apparatus according to claim 22, wherein the sprayer further comprises:
a nozzle for emitting the activating solution; and
an activating solution conduit for delivering the activating solution from an activating solution source to the nozzle.

34. The labeling apparatus according to claim 22, further comprising:
a container handling device for receiving containers at an inlet, directing the containers through a label application section, and directing the containers with the labels applied thereon to an outlet.

35. A method for applying labels to containers, comprising:
positioning a label to receive an activating solution from an activating solution sprayer, the label including an activatable adhesive layer;
spraying an activating solution onto the activatable adhesive layer to activate the activatable adhesive layer; and
contacting the activated layer with a surface of a container to adhere the label to the container.

36. The method of claim 35, further comprising the step of:
removing the label from a label dispenser prior to spraying the activating solution onto the activatable adhesive layer.

37. The method of claim 36, wherein the label dispenser dispenses an individual label from a label stack.

38. The method of claim 36, wherein the label dispenser dispenses a roll-fed label.

39. The method of claim 35, further comprising the step of:
releasably securing the label to a vacuum drum.

40. The method of claim 35, further comprising the step of:
releasably securing the label to a vacuum drum after spraying activating solution on the activatable surface.

41. The method of claim 35, further comprising the step of:
moving the label from the label dispenser to position the label within a spray zone of a spray nozzle for spraying the activating solution.

42. The method of claim 35, further comprising the step of:
moving at least one of the container and the label to cause the surface of the container to contact the label and adhere the activated label to a surface of the container.

43. The method of claim 35, further comprising the step of:
spraying the activating solution to cover at least a majority of surface area of the activatable adhesive layer.

44. The method of claim 35, further comprising the step of:
spraying the activating solution to cover less than a majority of the surface area of the activatable adhesive layer, in at least one of (i) a fixed pattern; (ii) a stripe; and (iii) a repeating pattern.

45. The method of claim 35, further comprising the step of:
moving the spray nozzle relative to the label while spraying the activating solution on the activatable adhesive layer.

46. The method of claim 41, further comprising the step of:
moving the label relative to the spray nozzle while spraying the activating solution on the activatable adhesive layer.

47. The method of claim 35, further comprising the step of:
engaging the labeled surface of the container with at least one of a wiper blade, an air stream, and a roller to enhance adherence of the label on the container.

48. The method of claim 35, wherein the surface tension of the activating solution is lower than the surface energy of the activatable adhesive layer.

49. A labeling apparatus for applying labels to containers, comprising:
a sprayer for delivering an activating solution onto an activatable adhesive layer of a label;
a label positioning mechanism for positioning the label while the activatable adhesive layer is sprayed with the activating solution; and
means for engaging the label with a surface of a container after the activatable adhesive layer is sprayed with the activating solution, to adhere the label to the surface of a container.

50. The labeling apparatus according to claim 49, further comprising:
at least one of a roller, a wiper blade and an air stream to engage the labeled surface of the container to enhance adherence of the label with the container surface.

51. The labeling apparatus according to claim 49, further comprising:
means for energizing the sprayer.

52. The labeling apparatus according to claim 49, wherein the sprayer further comprises:
a nozzle for emitting the activating solution; and
an activating solution conduit for delivering the activating solution from an activating solution source to the nozzle.

53. A container comprising a label on a surface thereof which has been applied by the method of claim 1, comprising an adhesive interface between the surface of the container and the label, wherein the adhesive interface comprises the activated adhesive layer.

54. The container of claim 53, wherein the adhesive interface is free of a transfer splitting pattern.

55. An apparatus for continuously applying labels to containers, comprising:
a conveyor for moving containers to be labeled;
a rotatable vacuum drum assembly;
a supply of roll-fed labels, wherein the labels comprise an activatable adhesive layer thereon and are dispensed singly onto a label-receiving face of the rotatable vacuum drum assembly; and
an activating solution assembly comprising an activating solution and a sprayer for delivering the activating solution, the activating solution assembly being disposed sufficiently adjacent to the vacuum drum assembly in order to deliver the activating solution to the activatable adhesive layer of the labels.

56. The apparatus of claim 55, further comprising a roller station comprising one or more rollers for pressing each label against the container, wherein the roller station is located at a section of the apparatus after the label has been adhered to the container.
